(19) United States
(12) Patent Application Publication
(10) Pub. No.: US 2008/0070672 A1
(43) Pub. Date: Mar. 20, 2008

(54) Slot machine and method for providing game

(75) Inventor: Yukinori Inamura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/892,564

(22) Filed: Aug. 23, 2007

(30) Foreign Application Priority Data
Aug. 25, 2006 (JP) 2006-229421

(51) Int. Cl. A63F 13/00

(52) U.S. Cl. 463/20

(57) ABSTRACT

A slot machine includes: a display device; an operation unit; and a controller that operates to: control the display device to variably display a plurality of symbols in each of a plurality of symbol display areas when a start command is input through the operation unit; set a pay line on at least a part of the symbol display areas; provide an award when a combination of the symbols displayed stopped in the symbol display areas, on which the pay line is set, satisfies an award providing combination; control the display device to additionally display a new symbol display area at a position next to one of the symbol display areas, when a predetermined condition is satisfied; and set a new pay line on at least a part of the symbol display areas including the new symbol display area.

### CROSS-REFERENCE TO THE RELATED APPLICATION(S)

The present application is based upon and claims priority from prior Japanese Patent Application No. 2006-229421, filed on Aug. 25, 2006, the entire content of which are incorporated herein by reference.

### TECHNICAL FIELD

The present invention relates to a slot machine and a method for providing a game in which an award is provided based on a combination of symbols displayed in symbol display areas configured with a pay line. The present invention also relates to a slot machine and a method for providing a game in which a new symbol display area configuring a new pay line is displayed when a predetermined condition is satisfied.

### BACKGROUND

Conventionally, a slot machine, as one type of gaming machines, is configured to start a game when a game medium such as a coin is inserted into the gaming machine by a player. When the game is started, symbol columns are displayed stopped in each of a plurality of display areas after being variably displayed for a predetermined time period. The slot machine provides an award to the player based on a combination of the symbols being displayed stopped.

The gaming machine is generally configured to determine whether or not an award providing combination of the symbols is satisfied to provide the award, by determining whether a predetermined number of symbols of the same kind (for example, “CHERRY” or “7”) are arranged on a predetermined pay line. Alternatively, the conventional gaming machine is configured that the award is provided based on the award providing combination without defining the pay line.

For example, documents U.S. Pat. No. 6,093,102 and U.S. Pat. No. 6,960,133 disclose a slot machine that displays a total of 15 symbols arranged in 3×5 matrix by video reels or mechanical reels. In the slot machine, vertically arranged columns of symbols start to variably displayed by rotating the reels when a game is started, and after a predetermined time lapses, three symbols are displayed stopped in each of the columns by stopping the rotation of the reels. An award is provided when the symbols are stop displayed in a combination including a predetermined number or more of symbols of the same kind.

In the conventional slot machine, the symbol display areas that display symbols establishing the combination are fixedly arranged in predetermined positions and in a predetermined number of pieces. That is, the number and positions of the symbol display areas displaying the symbols is fixedly defined in the slot machine and never been changed. For example, the slot machine disclosed in the document U.S. Pat. No. 6,093,102 is configured to display a total of 15 symbols in 15 fixed symbol display areas arranged in 3×5 matrix, with five video reels.

### SUMMARY

One of objects of the present invention is to provide a slot machine and a method for providing a slot game in which, when a predetermined condition is satisfied, a number of pay lines that establish an award providing combination is increased, to thereby provide a player a slot game improved in excitement, and improve expectations in the game.

According to a first aspect of the invention, there is provided a slot machine that provides a game, the slot machine including: a display device; an operation unit that allows a player to input commands for playing the game; and a controller that operates to: control the display device to variably display a plurality of symbols in each of a plurality of symbol display areas when a start command is input through the operation unit; set a pay line on at least a part of the symbol display areas; provide an award when a combination of the symbols displayed stopped in the symbol display areas, on which the pay line is set, satisfies an award providing combination; control the display device to additionally display a new symbol display area at a position next to one of the symbol display areas, when a predetermined condition is satisfied; and set a new pay line on at least a part of the symbol display areas including the new symbol display area.

According to a second aspect of the invention, there is provided a method for providing a game to a player, the method including: allowing a player to input commands for playing the game; variably displaying a plurality of symbols in each of a plurality of symbol display areas when a start command is input by the player; setting a pay line on at least a part of the symbol display areas; providing an award when a combination of the symbols displayed stopped in the symbol display areas, on which the pay line is set, satisfies an award providing combination; additionally displaying a new symbol display area at a position next to one of the symbol display areas, when a predetermined condition is satisfied; and setting a new pay line on at least a part of the symbol display areas including the new symbol display area.

### BRIEF DESCRIPTION OF THE DRAWINGS

In the accompanying drawings:

FIG. 1 is a view showing symbol display areas and activated pay lines, when a game is started with 1 BET, in a slot machine according to a first embodiment;

FIG. 2 is a view showing symbol display areas and activated pay lines, when the game is started with 2 BETs, in the slot machine according to the first embodiment;

FIG. 3 is a perspective view showing an appearance of the slot machine according to the first embodiment;

FIG. 4 is a front view showing a symbol display portion of the slot machine according to the first embodiment;

FIG. 5 is a view showing the symbol display portion in a case in which, when a player starts the game with 1 BET, symbols are stop displayed in a predetermined combination;

FIG. 6 is a view showing the symbol display portion in a case in which, when the player starts the game with 2 BETs, symbols are stop displayed in predetermined combinations;

FIG. 7 is a view showing the symbol display portion in a case in which, when the player starts the game with 3 BETs, symbols are stop displayed in predetermined combinations;

FIG. 8 is a payout table showing awards to be provided to the player based on combinations of symbols displayed along pay lines;

FIG. 9 is a block diagram schematically showing a control system of the slot machine according to the first embodiment;

FIG. 10 is a flowchart of a main control process program in the slot machine according to the first embodiment;

FIG. 11 is a flowchart of a main game process program in the slot machine according to the first embodiment;

FIG. 12 is a front view showing a symbol display portion of a slot machine according to a second embodiment; and

FIG. 13 is a front view showing a symbol display portion of a slot machine according to a third embodiment.

### DETAILED DESCRIPTION

Hereafter, a detailed description will be given, while referring to the drawings, of a slot machine according to the present invention, based on a first to a third embodiment in which embodied as a slot machine. The slot machine according to the following first to third embodiments is a so-called video slot machine having an image display device such as a liquid crystal display panel and provides a game by displaying an image of a plurality of symbols belonging to a plurality of kinds on the image display device.

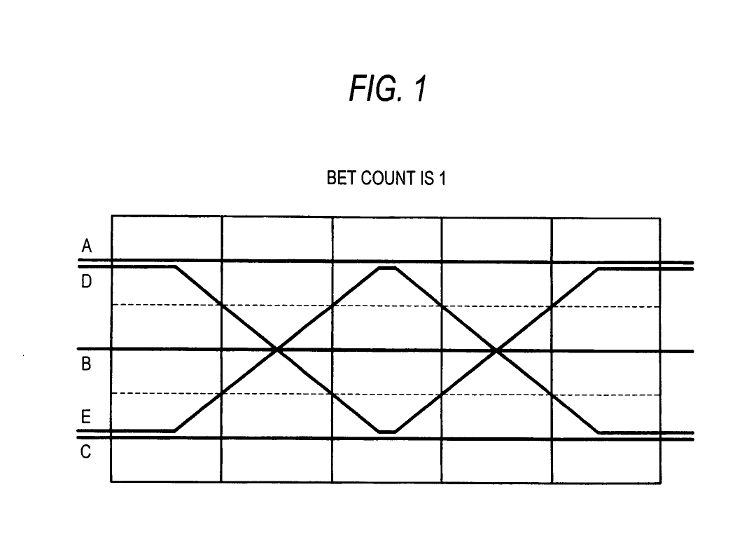

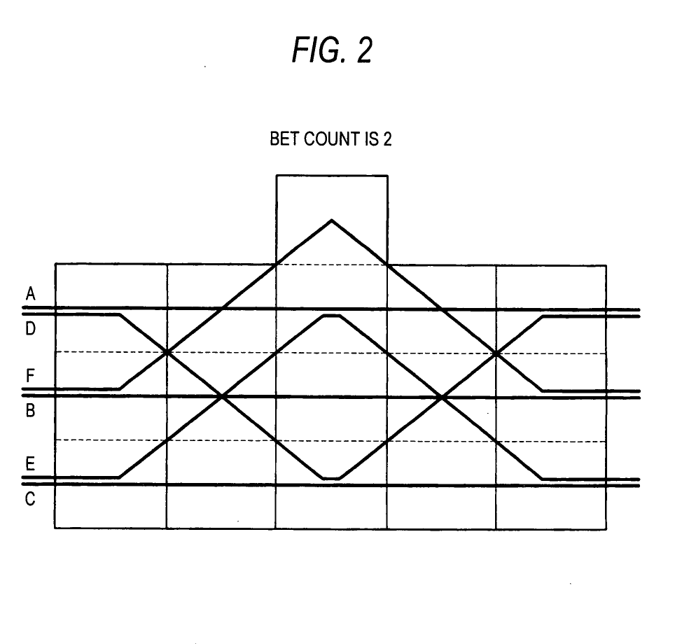

The slot machine according to the present invention, although it provides an award when a predetermined number or more of symbols of the same kind are arranged on one or more of activated pay lines, as one aspect of an award providing combination, as shown in FIGS. 1 and 2. The slot machine according to the present invention provides a newly added symbol display area and activates a newly added pay line configured on the symbol display areas including the added symbol display area, as a number of bets (bet count) made by the player increases. For example, when the bet count is 1, as shown in FIG. 1, an award is provided based on a combination of symbols displayed in symbol display areas arranged on any one of five pay lines A to E.

Meanwhile, when the bet count is 2, as shown in FIG. 2, an award is provided based on a combination of symbols displayed in symbol display areas arranged on a total of six pay lines A to F, in which the pay line F is newly added to the five pay lines A to E.

Accordingly, as a number of bets (bet count) accepted increases, the number of pieces of the symbol display areas and the number of pay lines that establishes the award providing combination are increased, whereby heightening a possibility of establishment of the award providing combination.

### First Embodiment

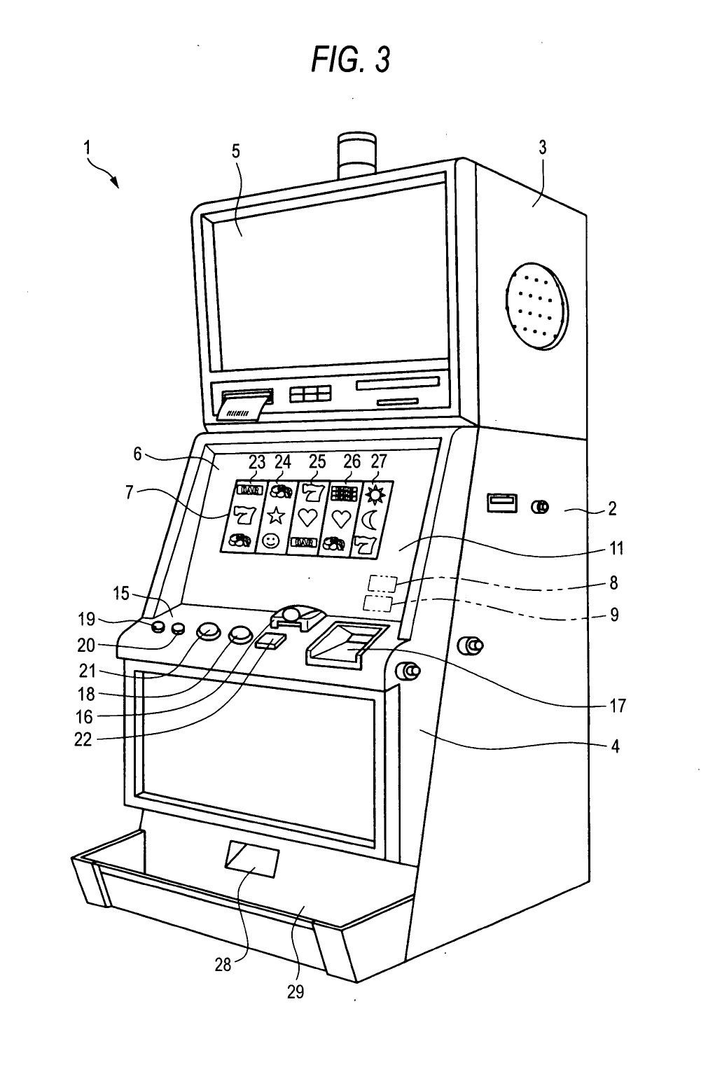

First, a description will be given, with reference to FIG. 3, of a configuration of a slot machine 1 according to a first embodiment. FIG. 3 is an external perspective view of the slot machine 1 according to the first embodiment.

The slot machine 1 according to the first embodiment includes a cabinet 2, a top box 3 mounted on top of the cabinet 2, and a main door 4 provided on a front of the cabinet 2.

An upper display 5 is provided on a front of the top box 3. The upper display 5 is provided with a liquid crystal display panel and displays various information related to the game, such as a method to play the game, a payout table, and the like.

A lower display 6 is provided on a front of the main door 4. The lower display 6 is provided with a liquid crystal display panel and has a symbol display portion 7 including symbol display areas arranged in 3×5 matrix. The symbol display portion 7 is configured to display five pieces of reels 23-27 and variably displays a column of predetermined arrangement of symbols by rotating the reels 23-27. The reels 23-27 are displayed stopped to display three to four symbols in each of the reels 23-27 after a predetermined time lapses. As a result, as described hereafter, a maximum of 15 to 20 pieces of symbols are displayed stopped in accordance with the progress of the game, and a predetermined award is provided to the player based on a combination of the symbols displayed stopped.

A touch sensitive screen 11 is provided on a front of the lower display 6. The touch sensitive screen 11 allows the player to input various instructions by a touch operation.

A credit count display portion 8 and a payout count display portion 9 are provided on the lower display 6. The credit count display portion 8 displays a credit count is a number of credits currently owned by a player. The symbol display portion 7 displays a payout count that is a total value of an award to be provided when the combination of symbols displayed stopped in the symbol display portion 7 corresponds to a predetermined award providing combination.

Below the lower display 6, there are provided a control panel 15 arranged with a plurality of buttons for accepting instructions input by the player relating to the game, a coin insertion slot 16 that accepts a coin as a game medium, and a bill insertion slot 17.

A START button 18, a CHANGE button 19, a CASH OUT button 20, a 1-BET button 21 and a MAX-BET button 22 are provided on the control panel 15. The START button 18 serves as an operation unit for inputting an instruction to start the scroll display of the symbol columns in the reels 23-27. The CHANGE button 19 serves as an operation unit used to request a changing of money from an attendant of a game arcade. The CASH OUT button 20 serves as an operation unit for inputting an instruction to provide (pay out) coins from a coin payout opening 28 into a coin tray 29, in accordance with the credit count owned by the player (one credit corresponds to one coin), or an instruction to provide a ticket printed with a bar-code.

The 1-BET button 21 serves as an operation unit for receiving an instruction to bet one credit, from among the credits which the player owns, on the game. The MAX-BET button 22 serves as an operation unit for receiving an instruction to bet a maximum credit count (in this embodiment, 6 credits), from among the credits which the player owns, which can be bet on one game. As the BET buttons, it is also possible to provide other various kinds of BET button, such as a 3-BET button.

In the slot machine 1 according to the first embodiment, a coin, a bill, or electronic valuable information (a credit) equivalent to them, is used as the game medium. However, the game medium applicable to the invention, not being limited to these, can include, for example, a medal, a token, electronic money or a ticket.

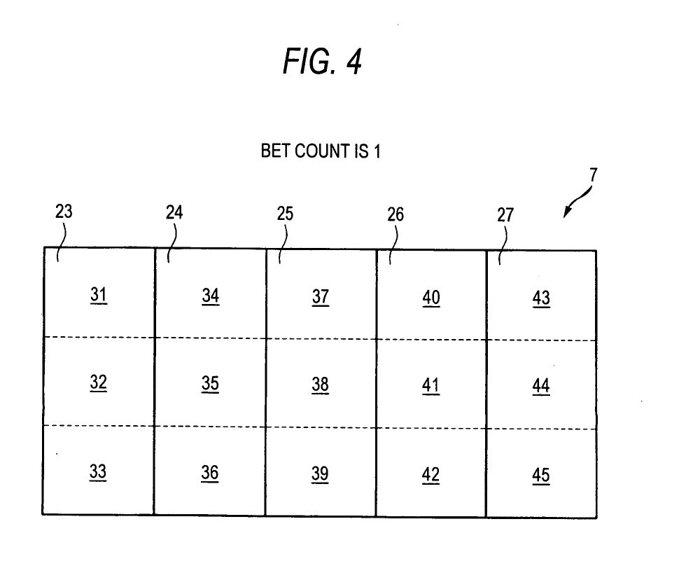

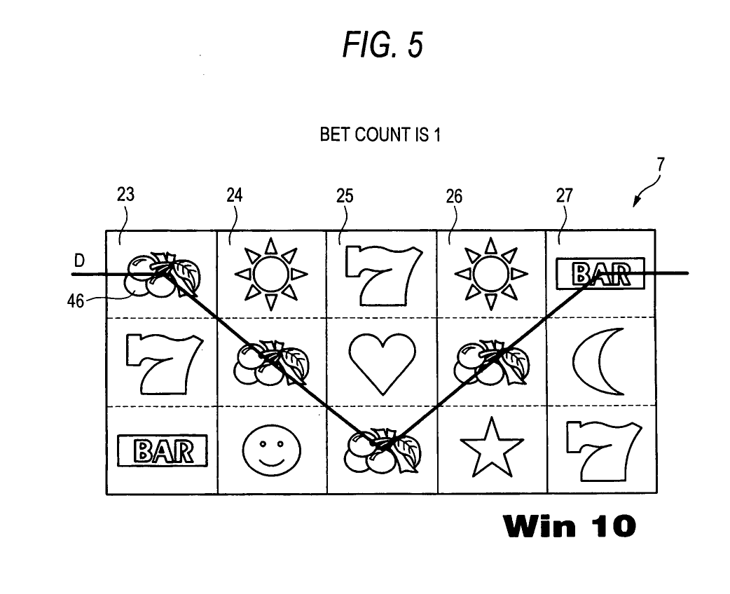

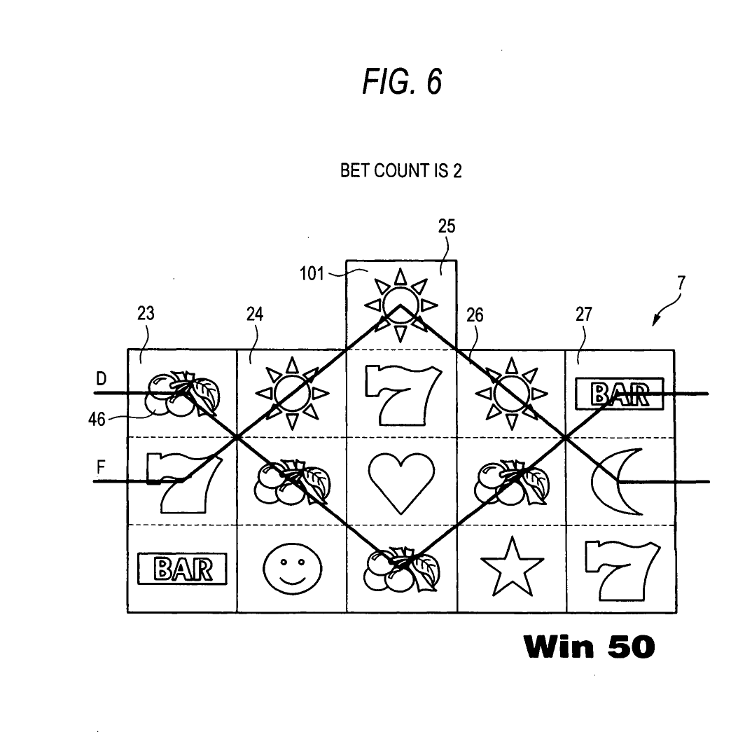

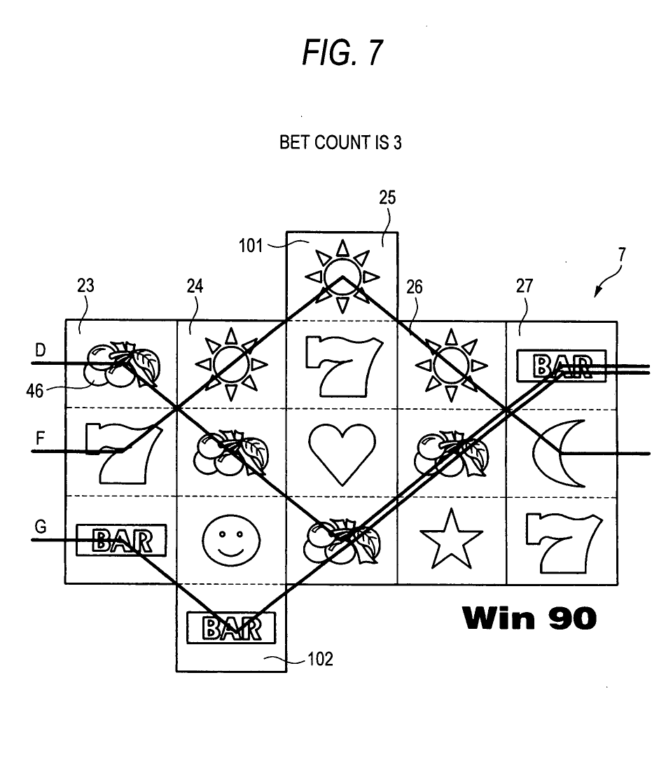

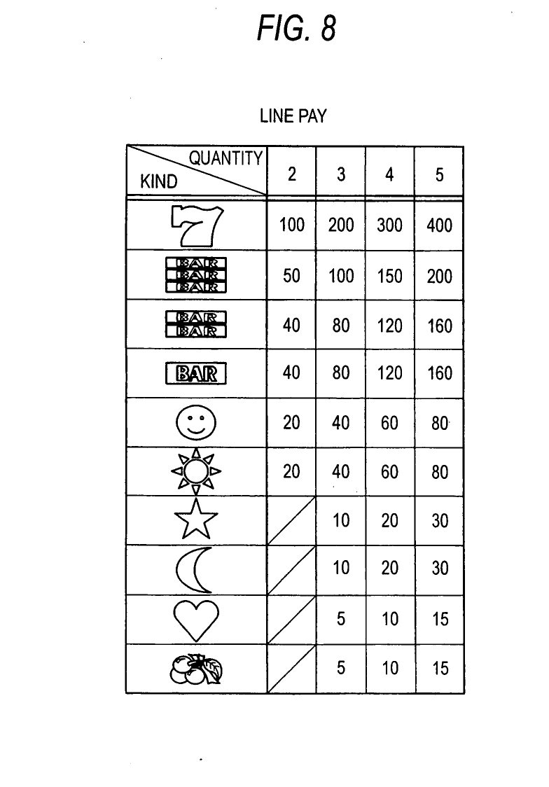

A description will be given, with reference to FIGS. 4-7, of symbols which are displayed in the symbol display portion 7 of the lower display 6 during the game. FIG. 4 is a front view showing the symbol display portion 7 according to the first embodiment. FIG. 5 is a view showing the symbol display portion 7 in a case in which the player starts the game with 1 BET, and symbols 46 are stop displayed in the symbol display areas. FIG. 6 is a view showing the symbol display portion 7 in a case in which the player starts the game with 2 BETs, and the symbols 46 are stop displayed in the symbol display areas. FIG. 7 is a view showing the symbol display portion 7 in a case in which the player starts the game with 3 BETs, and the symbols 46 are displayed in the symbol display areas. FIG. 8 is a view showing details of awards to be provided in the slot machine according to the first embodiment.

In the slot machine according to the first embodiment, symbols displayed on a pay line activated in the symbol display areas, which increase or decrease based on the number of bets made by the player at the start reception time, are elements of a combination which establishes an award. Along with the increase in the received bet count, new symbol display areas are provided in the symbol display portion 7. The number of pay lines also increases in conjunction therewith.

First, to give a description of a case in which the bet count received in the slot machine according to the first embodiment is 1, as shown in FIG. 4, the symbol display portion 7 according to the first embodiment is configured of the five pieces of reels 23-27. The reels 23-27 have symbol display areas 31-45 for displaying three symbols 46 on each reel 23-27 when a rotation of the reels 23-27 is stopped. Also, pay lines A to E (refer to FIG. 1) are set which connect some or all (in the first embodiment, five) of the symbol display areas in a predetermined order. Then, when the game is started, as shown in FIG. 5, the symbols 46 (a total of 15 symbols) are displayed one in each symbol display area 31-45. Although the symbol display areas 31-45 are divided by dotted lines in the figure in order to distinguish one area from another, it is also acceptable to configure in such a way as not to display these dotted lines.

In the slot machine 1 according to the first embodiment, the game is performed using 10 kinds of symbol 46 shown in FIG. 8 and a blank (a blank symbol). A win occurs when a combination is satisfied in which a predetermined number or more of symbols of the same kind are displayed in five symbol display areas (for example, the symbol display areas 31, 34, 37, 40 and 43) arranged on one of the pay lines A to F, and an award corresponding to a kind and a display quantity of the symbols is provided. Also, when a bonus combination is satisfied in which five “7” symbols 46 are arranged along one of the pay lines A to E, as an award, a bonus game is executed continuously after a finish of a base game.

Consequently, in the combination shown in FIG. 5, a combination is satisfied for which is provided an award of 10 credits based on a fact that four “CHERRY” symbols are displayed in the symbol display areas 31, 35, 39, 41 and 43 arranged on the pay line D.

Next, to give a description of a case in which the bet count received in the slot machine 1 according to the first embodiment is 2, in the symbol display portion 7 displayed on the lower display 6, a new symbol display area 101 is additionally displayed in contiguity with a top of the symbol display area 37 in contrast with the case of 1 BET. Along with this, a pay line F, which connects five symbol display areas 32, 34, 101, 40 and 44 including the symbol display area 101, is set anew. Then, when the game is started, as shown in FIG. 6, symbols 46 (a total of 16 symbols) are displayed one in each symbol display area 31-45 and 101. In the slot machine 1 according to the first embodiment, as described hereafter, a selection is performed for specifying an expansion direction in which the symbol display areas are expanded when the bet count increases. The new symbol display area 101 is additionally displayed in the direction specified as a result of the selection. For example, FIG. 6 shows the symbol display areas expanded in a case in which the expansion direction is specified as an upward direction. When the expansion direction is specified as a downward direction, the new symbol display area 101 is additionally displayed in contiguity with a bottom of the symbol display area 39.

Consequently, in the combinations shown in FIG. 6, combinations are established for which is provided an award of 50 credits in which are combined the award of 10 credits based on the fact that the four “CHERRY” symbols are displayed in the symbol display areas 31, 35, 39, 41 and 43 arranged on the pay line D, and an award of 40 credits based on a fact that three “SUN” symbols are displayed in the symbol display areas 32, 34, 101, 40 and 44 arranged on the pay line F.

Next, to give a description of a case in which the bet count received in the slot machine 1 according to the first embodiment is 3, in the symbol display portion 7 displayed on the lower display 6, a new symbol display area 102 is additionally displayed in contiguity with a bottom of the symbol display area 36 in contrast with the case of 2 BETs. Along with this, a pay line G, which connects five symbol display areas 33, 102, 39, 41 and 43 including the symbol display area 102, is set anew. Then, when the game is started, as shown in FIG. 7, symbols 46 (a total of 17 symbols) are displayed one in each symbol display area 31-45, 101 and 102. FIG. 7 shows the symbol display areas expanded in a case in which the expansion direction is specified as the downward direction. When the expansion direction is specified as the upward direction, the new symbol display area 102 is additionally displayed in contiguity with a top of the symbol display area 34.

Consequently, in the combinations shown in FIG. 7, combinations are established for which is provided an award of 90 credits in which are combined the award of 10 credits based on the fact that the four “CHERRY” symbols are displayed in the symbol display areas 31, 35, 39, 41 and 43 arranged on the pay line D, the award of 40 credits based on the fact that the three “SUN” symbols are displayed in the symbol display areas 32, 34, 101, 40 and 44 arranged on the pay line F, and an award of 40 credits based on a fact that two “1 BAR” symbols are displayed in the symbol display areas 33, 102, 39, 41 and 43 arranged on the pay line G.

Although no illustration is given for when the bet count is 4, 5 or 6, when the bet count is 4, a new symbol display area is additionally displayed in contiguity with a top of the symbol display area 40 or a bottom of the symbol display area 42 in contrast with the case of 3 BETs, and a pay line, by which the new symbol display area is connected, is added and set. Also, when the bet count is 5, a new symbol display area is additionally displayed in contiguity with a top of the symbol display area 31 or a bottom of the symbol display area 33 in contrast with the case of 4 BETs, and a pay line, by which the new symbol display area is connected, is added and set. Furthermore, when the bet count is 6, a new symbol display area is additionally displayed in contiguity with a top of the symbol display area 43 or a bottom of the symbol display area 45 in contrast with the case of 5 BETs, and a pay line, by which the new symbol display area is connected, is added and set.

In the first embodiment, a win occurs and an award is provided when a predetermined number of identical symbols is displayed on a pay line, but it is also acceptable to configure in such a way that a win occurs and an award is provided when a predetermined number or more of symbols of the same kind is displayed in symbol display areas regardless of the pay line.

A specific description will be given of a game implementation procedure of the slot machine according to the first embodiment. First, when the START button 18 is pressed after a finish of the bet reception, an expansion direction in which the symbol direction areas are expanded is selected by a lottery performed based on the number of bets made by the player and, in order to increase the number of symbol display areas, a display control is performed in such a way as to form a new symbol display area with which the symbol display portion 7 is expanded in the specified expansion direction.

Herein, it is described that the “expansion direction” is selected by the lottery. However, a position where the new symbol display area is to be displayed may be determined by simply performing a lottery to determine the position.

Subsequently, an internal selection process of determining symbols 46 to be displayed one in each symbol display area is performed, at a point at which a predetermined time has elapsed after the START button 18 is pressed, the reels 23-27 start rotating, the scroll display of the symbol columns is performed and, after the predetermined time lapses, 15 to 20 pieces of symbols 46 are stop displayed in 15 to 20 pieces of symbol display areas determined in accordance with the bet count. Then, details of an award are determined based on combinations of symbols stop displayed along 5 to 10 activated pay lines, and the award is provided.

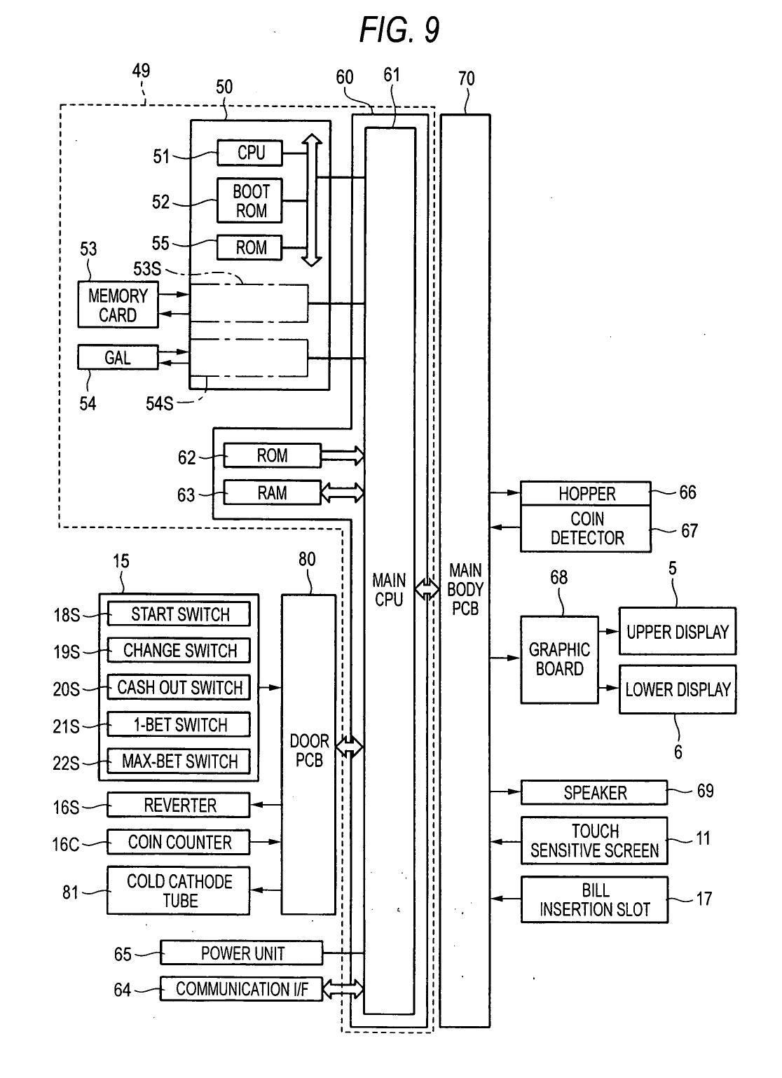

Next, a description will be given of a configuration relating to a control system of the slot machine 1 according to the first embodiment with reference to FIG. 9. FIG. 9 is a block diagram schematically showing the control system of the slot machine 1 according to the first embodiment.

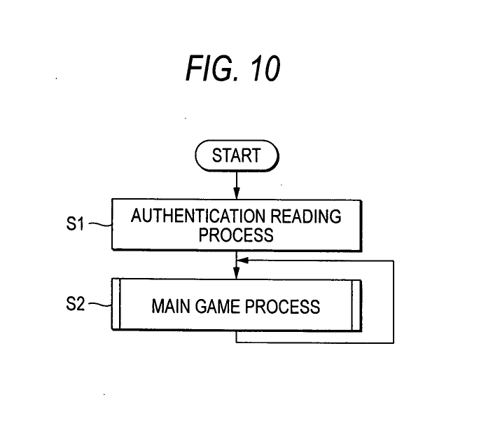

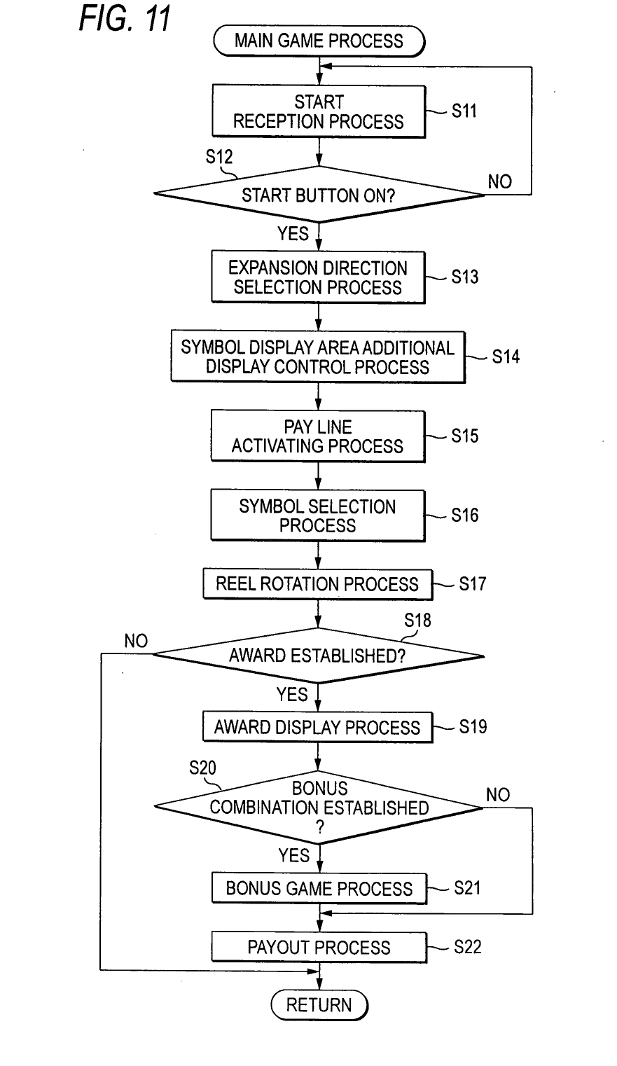

As shown in FIG. 9, the control system of the slot machine 1 is basically configured of a mother board 60 and a gaming board 50. A controller 49 that executes a control program (FIGS. 10 and 11) or the like, is provided on the mother board 60 and the gaming board 50.

First, to give a description of the gaming board 50, the gaming board 50 includes a CPU 51, an ROM 55 and a boot ROM 52, which are mutually connected via an internal bus, a card slot 53S compatible with a memory card 53, and an IC socket 54S compatible with a GAL (Generic Array Logic) 54.

The memory card 53, being configured of a nonvolatile memory, is a recording medium on which are recorded a game program and a game system program (referred to hereafter as a game program etc.). A selection program is included in the game program recorded on the memory card 53. The selection program is a program for determining symbols 46 to be stop displayed in the symbol display areas 31-45.

A symbol selection table for selecting symbols 46 to be stop displayed in the symbol display areas 31-45 is included in the memory card 53. The symbol selection table is a table in which a predetermined range of random numbers is correlated with symbols 46 to be stop displayed in the symbol display areas 31-45 (including an added symbol display area or areas in a case in which two bets or more have been received as the bet count). Then, first, symbols 46 to be stop displayed in the symbol display areas are selected based on the symbol selection table and, subsequently, an award to be provided to the player is determined based on a combination or combinations of the determined symbols 46.

The symbol selection table may also be a table in which the predetermined range of random numbers is correlated with awards to be provided to the player. In this case, first, based on the symbol selection table, an award to be provided to the player is selected and, subsequently, a combination or combinations of symbols 46 corresponding to the determined award are selected by a main CPU 61.

A description will be given of the mother board 60. The mother board 60, being configured using a commercially available general-purpose mother board (a printed circuit board mounted with basic parts of a personal computer), includes the main CPU 61, an ROM 62, an RAM 63 and a communication interface 64.

Permanent data, such as a program such as a BIOS, included in a memory device such as a flash memory and executed by the main CPU 61, are stored in the ROM 62. When the BIOS is executed by the main CPU 61, a process of initializing a predetermined peripheral device is performed, and a process of downloading the game program stored on the memory card 53 is started via the gaming board 50.

Data and a program used when the main CPU 41 operates are stored in the RAM 63. The RAM 63 can store various programs, such as an authentication program and the game program etc., which are read via the gaming board 50, and various information such as the credit count currently owned by the player.

The communication interface 64 is a communication device for establishing a communication with a server or the like, installed in the game arcade, via a communication line. A main body PCB 70 and a door PCB 80 are each connected to the mother board 60 via a USB. A power unit 65 is connected to the mother board 60. When power is supplied to the mother board 60 from the power unit 65, the main CPU 61 of the mother board 60 is booted up. The power is supplied to the gaming board 50 via a PCI bus, and the CPU 51 is booted up.

A hopper 66, a coin detector 67, a graphic board 68, a speaker 69, the touch sensitive screen 11, the bill insertion slot 17 and the like are connected to the main body PCB 70.

The graphic board 68, based on a control signal from the main CPU 61, controls image displays on the upper display 5 and the lower display 6. For example, the graphic board 68 displays a help screen and the payout table on the upper display 5, and performs the scroll display and stop display on the lower display 6 of the symbols 46 in conjunction with the rotation of the reels 23-27.

The control panel 15, a reverter 16S, a coin counter 16C and a cold cathode tube 81 are connected to the door PCB 80. A START switch 18S for the START button 18, a CHANGE switch 19S for the CHANGE button 19, a CASH OUT switch 20S for the CASH OUT button 20, a 1-BET switch 21S for the 1-BET button 21, and a MAX-BET switch 22S for the MAX-BET button 22 are provided on the control panel 15. Each switch, when the corresponding button is operated by the player, transmits an input signal to the main CPU 61.

A detailed description will be given, while referring to the drawings, of a main control program executed by the slot machine 1 according to the first embodiment. FIG. 10 is a flowchart of the main control program.

It is assumed that the slot machine 1 already has the memory card 53 inserted in the card slot 53S of the gaming board 50, and the GAL 54 attached to the IC socket 54S.

First, when the power is turned on in the power unit 65, the mother board 60 and the gaming board 50 are each booted up, and an authentication reading process of step (abbreviated hereafter to S) 1 is executed. In the authentication reading process, the mother board 60 and the gaming board 50 each perform a distinct process in parallel.

That is, in the gaming board 50, the CPU 51 performs a reading of a preliminary authentication program stored in the boot ROM 52 and, in accordance with the preliminary authentication program read, performs a preliminary authentication which confirms and certifies in advance that no alteration of the authentication program has been performed, before it is downloaded onto the mother board 60.

Meanwhile, in the mother board 60, the main CPU 61 executes the BIOS stored in the ROM 62 and, expanding compressed data embedded in the BIOS to the RAM 63, performs an execution of the BIOS expanded to the RAM 63, and a diagnosis and initialization of each kind of peripheral device.

Subsequently, the main CPU 61 reads the authentication program stored in the ROM 55, and performs an authentication which confirms and certifies that the game program etc. stored in the memory card 53 inserted in the card slot 53S has not been altered. When this authentication process finishes normally, the main CPU 61 writes the game program etc. subjected to the authentication (authenticated) onto the RAM 63. Continuing on, the main CPU 61 performs a downloading process of reading payout ratio setting data stored in the GAL 54 via the gaming board 50, and writes the read payout ratio setting data onto the RAM 63.

After performing the heretofore described processes, the main CPU 61 finishes the authentication reading process.

In S2, the main CPU 61 performs a main game process by sequentially reading the game program etc. authenticated in the heretofore described authentication reading process of S1 from the RAM 63 and executing them. By executing this main game process, the game on the slot machine 1 according to the first embodiment is performed. The main game process is repeatedly executed for as long as the power is being supplied to the slot machine 1.

Next, a description will be given, based on FIG. 11, of a sub-process of the heretofore described main game process of S2. FIG. 11 is a flowchart of a main game process program in the slot machine 1 according to the first embodiment. Each of the following programs shown in the flowchart of FIG. 11, being stored in the memory card 53, is expanded to the RAM 63 furnished on the slot machine 1, and executed by the main CPU 61.

First, as shown in FIG. 11, in S11, the main CPU 61, after performing a predetermined initial setting, performs a start reception process of allowing a coin insertion and setting a bet count or the like. At this time, in the initialization process, a process of clearing data of items set in a predetermined data area (for example, a payout count counter or the like) and so on is performed. Also, in the start reception process, the player performs the coin insertion and a betting operation of using the 1-BET button 21 or the MAX-BET button 22 to set a bet count in a current game at one of 1 to 6.

Next, in S12, the main CPU 61 performs a judgment as to whether or not the START button 18 is pressed. The judgment as to whether or not the START button 18 is pressed is performed based on whether or not the input signal from the START switch 18S has been received.

Then, if the START button 18 has not been pressed (S12: NO), the main CPU 61 returns again to the start reception process (S11). At this time, an operation, such as a revision or the like of the bet count, is possible. Contrarily, if the START button 18 is pressed (S12: YES), the main CPU 61, as well as subtracting the bet count set based on the operation of the 1-BET button 21 or the MAX-BET button 22 from the owned credit count, stores a result in the RAM 63 as bet information.

Subsequently, in S13, the main CPU 61 selects an expansion direction in which the symbol display areas are expanded. Specifically, in the first embodiment, one of the upward direction and the downward direction is selected as the expansion direction. Then, if the upward direction has been selected as the expansion direction, a new symbol display area is displayed in contiguity with an upper side of the symbol display area 31, 34, 37, 40 or 43. As opposed to this, if the downward direction has been selected, a new symbol display area is displayed in contiguity with a lower side of the symbol display area 33, 36, 39, 42 or 45. In the heretofore described S13, the selection of the expansion direction is performed a number of times equivalent to a number of symbol display areas to be additionally displayed.

Next, in S14, the main CPU 61, based on the bet count received in the heretofore described start reception process of S11, and on the expansion direction specified in the heretofore described S13, performs a display control of the lower display 6 in such a way as to additionally display the new symbol display area in contiguity with the symbol display areas 31-45 being currently displayed (refer to FIGS. 6 and 7). In the slot machine 1 according to the first embodiment, one symbol display area is added every time one is added to the bet count. Also, if only 1 BET has been received, the game is performed in the following way using only the symbol display areas 31-45, without newly displaying any symbol display area on the lower display 6.

In S15, the main CPU 61 newly sets a pay line which connects the symbol display area newly displayed in the heretofore described S14. For example, as shown in FIG. 2, if the new symbol display area 101 has been additionally displayed in contiguity with the top of the symbol display area 37, the pay line F, which connects the five symbol display areas 32, 34, 101, 40 and 44 including the symbol display area 101, is newly set.

In S16, the main CPU 61 executes a symbol selection process of selecting symbols to be displayed in the symbol display areas 31-45, and the newly added symbol display area, in the symbol display portion 7. Specifically, the main CPU 61, by executing a random number generation program included in the selection program stored in the RAM 63, samples random numbers from within a numeric range in the predetermined range of random numbers and, based on the sampled random numbers and the symbol selection table, determines 15 to 20 symbols 46 (that is, stop positions of the reels 23-27), from among a plurality of kinds of symbol, to be displayed in the symbol display areas.

In S17, the main CPU 61 starts the rotation of the reels 23-27, and scroll displays the symbol columns disposed on the reels 23-27 at a predetermined rate. Subsequently, after the predetermined time lapses, the reels 23-27 are stop displayed in an order of the reel 23-> the reel 24-> the reel 25-> the reel 26-> the reel 27, and three or four symbols 46 are displayed on each reel 23-27 (refer to FIGS. 5-7).

In S18, the main CPU 61 determines whether or not a combination of symbols 46 displayed on the pay line activated in the symbol display areas is a specific combination for which any award is provided.

The main CPU 61, if it determines that the combination is the award payout combination (S18: YES), moves to S19. Contrarily, the main CPU 61, if it determines that it is not the award payout combination (S18: NO), finishes the main game process. If the game continues to be started from next time onwards, the processes from S1 onward are performed again.

In S19, the main CPU 61, by displaying an award based on the established combinations on the lower display 6, notifies the player of details of the award. For example, in FIG. 6, combinations are established in which four “CHERRY” symbols are displayed on the pay line D, and three “SUN” symbols are displayed on the pay line F and, as a result, letters “Win 50” notifying that a total of 50 credits are provided as the award are displayed.

In S20, the main CPU 61 determines whether or not the combination of symbols 46 displayed on the pay line activated in the symbol display areas has established a bonus combination by means of the heretofore described reel rotation process of S16. The bonus combination is a combination in which five “7” symbols 46 are arranged along the pay line.

As a result, the main CPU 61, if it determines that the bonus combination has been established (S20: YES), moves to a bonus game process (S21). Although it is possible to consider various modes as the bonus game, herein, a description will be given with a free game taken as the bonus game. The free game being a game in which a game equal to the base game is performed a predetermined number of times, a rotation and stop control of the reels 23-27 is repeatedly performed a predetermined number of times in the heretofore mentioned bonus game process of S21, an award established during which is provided to the player in a payout process of S22, to be described hereafter. As conditions of making a transition to the bonus game, it is possible to set various conditions under which it is acceptable to either make the transition when a predetermined number or more of predetermined symbols are displayed, or arrange that the transition occurs suddenly for some unknown reason. As a selection table used during the free game, it is also acceptable to employ a selection table set in such a way as to pay out more than in the base game.

In S22, the main CPU 61 pays the player an award based on a combination of the displayed symbols. At this time, by pressing the CASH OUT button 20, it is possible to provide the award as coins for the credit count (one credit corresponds to one coin), and it is also possible to provide the award by discharging a ticket printed with a bar-code indicating the value of the award.

As described heretofore, in the slot machine 1 according to the first embodiment, at when starting the game, by the player's operation using the 1-BET button 21 or the MAX-BET button 22, the bet count in the current game is received as one of 1 to 6 (S11), and An expansion direction in which the symbol display areas are expanded is selected (S13). Next, a number of symbol display areas corresponding to the received bet count is additionally displayed in the expansion direction specified as a result of the selection (S14), and the new pay line or pay lines are set which connect the additionally displayed symbol area or areas (S15). Subsequently, the reels 23-27 all start rotating, a total of 15 to 20 symbols 46 are stop displayed on the symbol display areas after the predetermined time lapses, and an award is provided to the player based on a combination of symbols 46 displayed along the activated pay lines (S22), so it is possible, under a predetermined condition, to increase the symbol display areas which display symbols, and the pay lines which establish the award providing combination. Consequently, it is possible to raise expectations for the game, and provide the player with an interesting game.

Also, by increasing the bet count, as the pay lines which establish the award providing combination increase, it is possible to cause the player to perform the game with a larger bet count.

In the first embodiment, it is described that the reels 23-27 are displayed on the lower display 6 that is provided with a liquid crystal display panel, which means that in the above description, the reels 23-27 are configured as video reels. However, the slot machine 1 may be provided with a display device including a plurality of mechanical reels on which the symbols are arranged to perform the variable display as described in the above.

### Second Embodiment

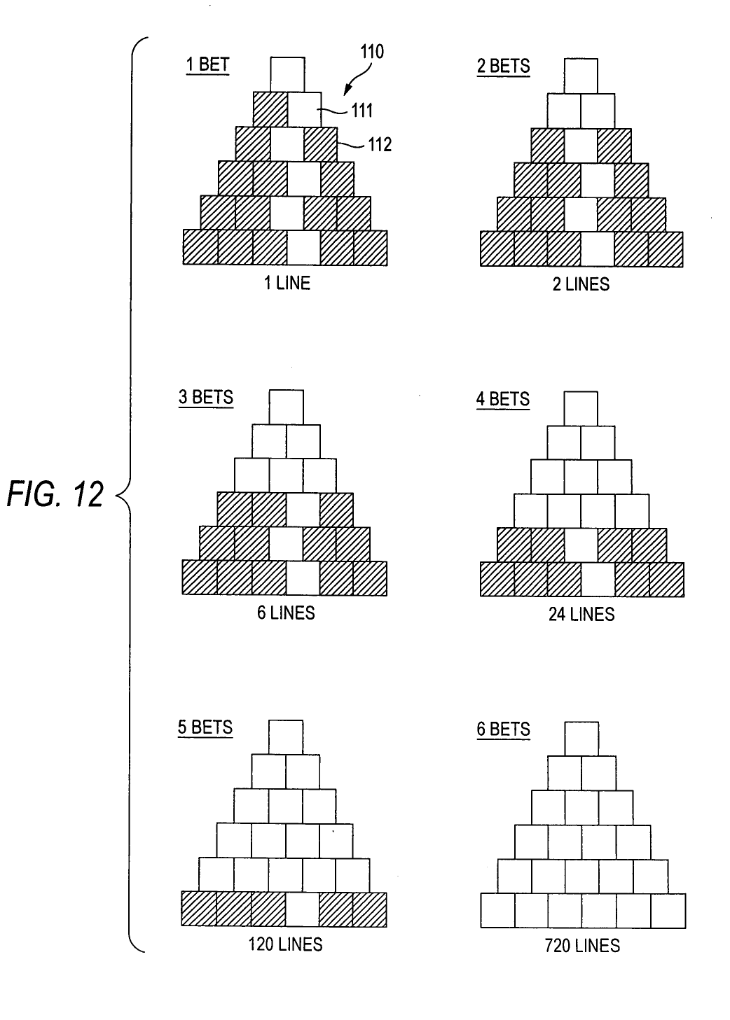

Next, a description will be given with reference to FIG. 12 of a slot machine according to a second embodiment. In the following description, the same reference numerals as those of the components of the slot machine 1 according to the first embodiment shown in FIGS. 1-11 designate parts identical or equivalent to the components of the slot machine 1 or the like according to the heretofore described first embodiment.

A configuration of the slot machine according to the second embodiment is substantially the same as that of the slot machine 1 according to the first embodiment. Also, each kind of control process is also substantially the same as that of the slot machine 1 according to the first embodiment.

However, the slot machine 1 according to the first embodiment, in accordance with the received bet count, adds the new symbol display area or areas in contiguity with the already displayed symbol display areas 31-45, and sets the new pay line or pay lines, while the slot machine according to the second embodiment differs from the slot machine 1 according to the first embodiment in that it, in accordance with the received bet count, increases activated symbol display areas arranged on a pay line or pay lines, and sets a new pay line or pay lines.

Hereafter, a description will be given, based on FIG. 12, of a symbol display portion 110 displayed on the lower display 6 of the slot machine according to the second embodiment. FIG. 12 is a front view showing the symbol display portion 110 according to the second embodiment.

In the slot machine according to the second embodiment, symbols displayed on the pay line or pay lines set on the activated symbol display areas, which increase or decrease based on the number of bets made by the player at the start reception time, are elements of the award providing combination. Specifically, along with the received bet count increasing, the activated symbol display areas 111 increase. A number of pay lines set also increases in conjunction therewith.

First, to give a description of a case in which the bet count received in the slot machine according to the second embodiment is 1 BET, as shown in FIG. 12, in the symbol display portion 110 according to the second embodiment, one symbol display area in each tier, from among pyramid-shaped symbol display areas disposed in six tiers, is taken to be the activated symbol display area 111, and the others are taken to be non-activated symbol display areas 112 which are not arranged on any pay line. Consequently, only one pay line is set which connects six activated symbol display areas 111 in an up and down direction.

When the game is started, symbols (not shown) are scroll displayed in each activated symbol display area 111 and, when the scrolling is stopped, symbols (a total of six symbols) are displayed one in each activated symbol display area 111. It is also acceptable to display symbols not only in the activated symbol display areas 111, but also in the non-activated symbol display areas 112.

As a result, a win occurs when a combination is satisfied in which a predetermined number or more of symbols of the same kind is displayed in the six symbol display areas arranged on the set pay line, and an award corresponding to a kind and a display quantity of the symbols is provided.

Next, to give a description of a case in which the bet count received in the slot machine according to the second embodiment is 2, in the symbol display portion 110 displayed on the lower display 6, all symbol display areas in a second tier are the activated symbol display areas 111 in contrast with the case of 1 BET. Consequently, a total of two pay lines are set which connect the activated symbol display areas in the up and down direction.

Then, when the game is started, symbols (not shown) are scroll displayed in each activated symbol display area 111 and, when the scrolling is stopped, symbols (a total of seven symbols) are displayed one in each activated symbol display area 111.

As a result, a win occurs when a combination is satisfied in which a predetermined number or more of symbols of the same kind is displayed in the six symbol display areas arranged on each set pay line, and an award corresponding to a kind and a display quantity of the symbols is provided.

Next, to give a description of a case in which the bet count received in the slot machine according to the second embodiment is 3, in the symbol display portion 110 displayed on the lower display 6, all symbol display areas in a third tier are the activated symbol display areas 111 in contrast with the case of 2 BETs. Consequently, a total of six pay lines are set which connect the activated symbol display areas in the up and down direction.

When the game is started, symbols (not shown) are scroll displayed in each activated symbol display area 111 and, when the scrolling is stopped, symbols (a total of nine symbols) are displayed one on each activated symbol display area 111.

As a result, a win occurs when a combination is satisfied in which a predetermined number or more of symbols of the same kind is displayed in the six symbol display areas arranged on each set pay line, and an award corresponding to a kind and a display quantity of the symbols is provided.

Thereafter, in the same way, in a case in which the bet count received in the slot machine according to the second embodiment is 4, 5 or 6, as shown in FIG. 12, the activated symbol display areas 111 increasing in increments, the pay lines connecting the activated symbol display areas 111 also increase.

### Third Embodiment

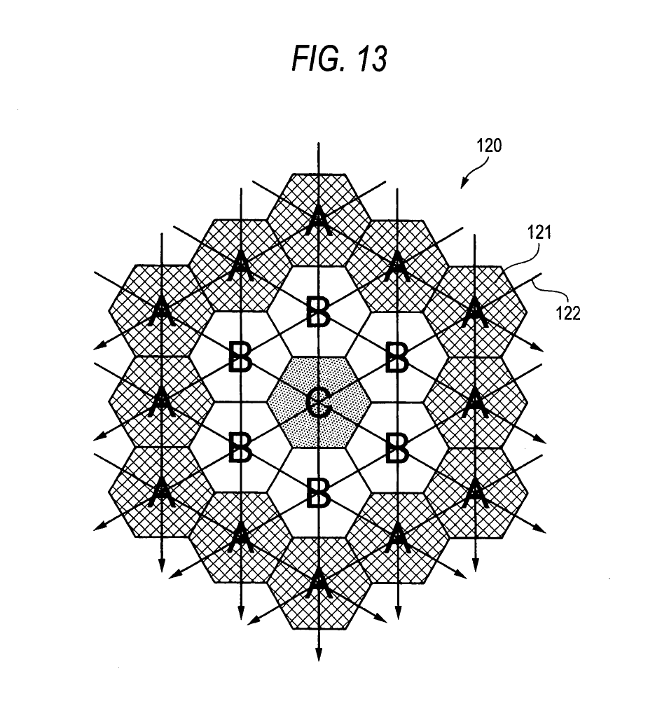

Next, a description will be given, based on FIG. 13, of a slot machine according to a third embodiment. In the following description, the same reference numerals as those of the components of the slot machine 1 according to the first embodiment in FIGS. 1-11 designate parts identical or equivalent to the components of the slot machine 1 or the like according to the heretofore described first embodiment.

A configuration of the slot machine according to the third embodiment is substantially the same as that of the slot machine 1 according to the first embodiment. Also, each kind of control process is also substantially the same as that of the slot machine 1 according to the first embodiment.

However, the slot machine 1 according to the first embodiment, in accordance with the received bet count, adds the new symbol display area or areas in contiguity with the symbol display areas 31-45 disposed in a matrix formation, and sets the new pay line or pay lines, while the slot machine according to the third embodiment differs from the slot machine 1 according to the first embodiment in that it, in accordance with the received bet count, adds new symbol display areas in contiguity with approximately concentrically disposed symbol display areas, and sets new pay lines connecting the new symbol display areas.

Hereafter, a description will be given with reference to FIG. 13 of a symbol display portion 120 displayed on the lower display 6 of the slot machine according to the third embodiment. FIG. 13 is a front view showing the symbol display portion 120 according to the third embodiment.

In the slot machine according to the third embodiment, a symbol or symbols displayed on a pay line or pay lines set on the symbol display areas, which increase or decrease based on the number of bets made by the player at the start reception time, are elements of the award providing combination. Along with the received bet count increasing, symbol display areas 121 increases in numbers to be displayed. A number of pay lines 122 set also increases in conjunction therewith.

First, to give a description of a case in which the bet count received in the slot machine according to the third embodiment is 1, as shown in FIG. 13, in the symbol display portion 120 according to the third embodiment, a C symbol display area 121 arranged in a center, from among the concentrically disposed symbol display areas having a hexagonal shape, is displayed. Consequently, only one pay line 122 is set which connects the displayed C symbol display area 121.

Then, when the game is started, symbols (not shown) are scroll displayed in the C symbol display area 121 and, when the scrolling is stopped, one symbol is displayed in the symbol display area 121.

As a result, a win occurs when a combination is satisfied in which a specific symbol is displayed in the symbol display area arranged on the set pay line 122, and an award corresponding to a kind and a display quantity of the symbol is provided.

Next, to give a description of a case in which the bet count received in the slot machine according to the third embodiment is 2, new B symbol display areas are displayed in the symbol display portion 120 displayed on the lower display 6, in contiguity with a periphery of the C symbol display area in contrast with the case of 1 BET. Consequently, a total of nine pay lines 122 are set which connect the displayed B and C symbol display areas 121.

Then, when the game is started, symbols (not shown) are scroll displayed in the B and C symbol display areas 121 and, when the scrolling is stopped, symbols (a total of seven symbols) are displayed one in each symbol display area 121.

As a result, a win occurs when a combination is satisfied in which a predetermined number or more of symbols of the same kind is displayed in the symbol-display areas arranged on the activated pay lines 122, and an award corresponding to a kind and a display quantity of the symbols is provided.

Next, to give a description of a case in which the bet count received in the slot machine according to the third embodiment is 3, new A symbol display areas are displayed in the symbol display portion 120 displayed on the lower display 6, in contiguity with a periphery of the B symbol display areas in contrast with the case of 2 BETs. Consequently, a total of 15 pay lines 122 are set which connect the displayed A to C symbol display areas 121.

When the game is started, symbols (not shown) are scroll displayed in the A to C symbol display areas 121 and, when the scrolling is stopped, symbols (a total of 19 symbols) are displayed one in each activated symbol display area 121.

As a result, a win occurs when a combination is satisfied in which a predetermined number or more of symbols of the same kind are displayed in the symbol display areas arranged on the activated pay lines 122, and an award corresponding to a kind and a display quantity of the symbols is provided.

The present invention is not limited to the heretofore described embodiments. The present invention may be applied various gaming machine with improvements and modifications without departing from the scope of the present invention.

For example, in the first to third embodiments, on condition that the received bet count increases, the symbol display area or areas are added, along with which the new pay line or pay lines are set, but it is also acceptable to make other than the bet count a condition. For example, it is also possible to increase the symbol display areas when a payout ratio reaches 90% or less, and to reduce the symbol display areas when the payout ratio reaches 95% or more.

Also, when a combination of symbols is a predetermined combination, it is also possible to increase the symbol display areas for several games from a next game. For example, when four “1 BAR” symbols or more are displayed on a pay line, it is also acceptable, for 10 games from the next game, to additionally display one new symbol display area, and set one new pay line connecting the added symbol display area. Also, when four “2 BAR” symbols or more are displayed on a pay line, it is also acceptable, for 10 games from the next game, to additionally display two new symbol display areas, and set two new pay lines connecting the added symbol display areas. Also, when four “3 BAR” symbols or more are displayed on a pay line, it is also acceptable, for 10 games from the next game, to additionally display three new symbol display areas, and set three new pay lines connecting the added symbol display areas.

Also, in the first embodiment, it is arranged that a direction in which the symbol display areas are expanded is selected in the selection to be one of the upward direction and the downward direction, and the new symbol display area or areas are displayed in contiguity in the selected expansion direction, but it is also acceptable to display the new symbol display area or areas only in a predetermined direction. Also, it is also acceptable to cause the player to select the expansion direction.

As described above with reference to the embodiments, there is provided a slot machine and a method for providing a game to a player, in which when the predetermined condition is satisfied, a new symbol display area for displaying a symbol is displayed, and a new pay line connecting the displayed new symbol display area is set, so it is possible, by variously changing a combination pattern of symbols to be activated, to provide the player with the interesting game. Also, by changing the possibility of establishment of the award providing combination, expectations for the game are raised.

Also, by the received bet count increasing, as the controller increases a number of pay lines to be set, the possibility of establishment of the award providing combination is heightened, enabling the player to perform the game with a larger bet count.

That is, in the heretofore known slot machine, as the pay line which establishes a combination for which any award is provided, being fixed in advance by the slot machine, never changes, the game becomes monotonous, and it has not been possible to challenge the player to bet a larger number of game media, but it is possible in the invention to solve this kind of problem.

It is described in the embodiments that the award is “provided” to the player in accordance with the combination of the symbols displayed stopped in the second arrangement. However, the award may be any type of award that is advantageous to the player in playing the game.

The award may be provided to the player by providing the player a bonus game such as a free game, which is played without consumption of any game medium (coins, medals, tokens, or credits), or a second game, which is different from the base game and is more advantageous to the player.

The award may also be provided to the player by transitioning the game to be performed based on an award table having higher odds than the award table shown in FIG. 8 used in the base game.

The award may also be provided to the player by actually paying out tangible game medium (coins, medals, or tokens) to the player, or by paying out non-tangible credits as the game medium to the player. The credits may be accumulated in the gaming machine to be actually paid out later as the tangible game medium.

As described with reference to the embodiments, there is provided a slot machine that provides a game, the slot machine including: a display device; an operation unit that allows a player to input commands for playing the game; and a controller that operates to: control the display device to variably display a plurality of symbols in each of a plurality of symbol display areas when a start command is input through the operation unit; set a pay line on at least a part of the symbol display areas; provide an award when a combination of the symbols displayed stopped in the symbol display areas, on which the pay line is set, satisfies an award providing combination; control the display device to additionally display a new symbol display area at a position next to one of the symbol display areas, when a predetermined condition is satisfied; and set a new pay line on at least a part of the symbol display areas including the new symbol display area.

There is also provided a method for providing a game to a player, the method including: allowing a player to input commands for playing the game; variably displaying a plurality of symbols in each of a plurality of symbol display areas when a start command is input by the player; setting a pay line on at least a part of the symbol display areas; providing an award when a combination of the symbols displayed stopped in the symbol display areas, on which the pay line is set, satisfies an award providing combination; additionally displaying a new symbol display area at a position next to one of the symbol display areas, when a predetermined condition is satisfied; and setting a new pay line on at least a part of the symbol display areas including the new symbol display area.

What is claimed is:

1. A slot machine that provides a game, the slot machine comprising:
a display device;
an operation unit that allows a player to input commands for playing the game; and
a controller that operates to:
control the display device to variably display a plurality of symbols in each of a plurality of symbol display areas when a start command is input through the operation unit;
set a pay line on at least a part of the symbol display areas;
provide an award when a combination of the symbols displayed stopped in the symbol display areas, on which the pay line is set, satisfies an award providing combination;
control the display device to additionally display a new symbol display area at a position next to one of the symbol display areas, when a predetermined condition is satisfied; and
set a new pay line on at least a part of the symbol display areas including the new symbol display area.

2. The slot machine according to claim 1, wherein the controller further operates to:
accept a bet input by the player through the operation unit; and
determine a detail of the award in accordance with the bet.

3. The slot machine according to claim 2, wherein the controller controls the display device to additionally display the new symbol display area when a number of bet made by the player through the operation unit reaches a predetermined bet count.

4. The slot machine according to claim 1, wherein the controller further operates to perform a lottery to determine the position where the new symbol display area is to be displayed, and
wherein the controller controls the display device to additionally display the new symbol display area at the position determined by the lottery.

5. The slot machine according to claim 1, wherein the display device includes a display panel that displays various images on a screen, the images including a plurality of video reels on which the symbols are arranged.

6. The slot machine according to claim 1, wherein the display device includes a plurality of mechanical reels on which the symbols are arranged.

7. A method for providing a game to a player, the method comprising:
allowing a player to input commands for playing the game;
variably displaying a plurality of symbols in each of a plurality of symbol display areas when a start command is input by the player;
setting a pay line on at least a part of the symbol display areas;
providing an award when a combination of the symbols displayed stopped in the symbol display areas, on which the pay line is set, satisfies an award providing combination;
additionally displaying a new symbol display area at a position next to one of the symbol display areas, when a predetermined condition is satisfied; and
setting a new pay line on at least a part of the symbol display areas including the new symbol display area.

8. The method according to claim 7 further comprising:
accepting a bet input by the player; and
determining a detail of the award in accordance with the bet.

9. The method according to claim 8, wherein the new symbol display area is additionally displayed when a number of bet made by the player through the operation unit reaches a predetermined bet count.

10. The method according to claim 7 further comprising performing a lottery to determine the position where the new symbol display area is to be displayed,
wherein the new symbol display area is additionally displayed at the position determined by the lottery.
